(19) United States
(12) Patent Application Publication
(10) Pub. No.: US 2008/0114820 A1
(43) Pub. Date: May 15, 2008

(54) Apparatus and method for high-speed modulo multiplication and division

(76) Inventors: Alaaeldin Amin, Dhahran (SA); Muhammad Y. Mahmoud, Dhahran (SA)

Correspondence Address: LITMAN LAW OFFICES, LTD., P.O. BOX 15035, CRYSTAL CITY STATION, ARLINGTON, VA, 22215, US

(21) Appl. No.: 11/599,481

(22) Filed: Nov. 15, 2006

(51) Int. Cl. G06F 7/72; G06F 5/01

(52) U.S. Cl. 708/209; 708/491

(57) ABSTRACT

The method for high-speed modulo multiplication is a method for multiplying integers A and B modulus N that is optimized for high speed implementation in an electronic device, which may be implemented in software, but is preferably implemented in hardware. The multiplication is performed on devices requiring no more than k+2 bits, where k is the number of significant bits in A, B, and N. The method computes the running product bᵢᵢAW, where AW is either A when the previous running product is negative, or W when the previous running product is positive, W being the N-conjugate of A formed by A−N. On each iteration, the magnitude of the running product is reduced by a scaling factor no greater than 2N according to the state of the two most significant bits of the running product when carry propagate adders are used.

### BACKGROUND OF THE INVENTION

1. Field of the Invention

The present invention relates to high performance digital arithmetic algorithms and circuitry. In particular, the present invention relates to apparatus and method for high-speed modulo multiplication and division particularly useful of the implementation of data encryption in computer systems and networks.

2. Description of the Related Art

Advances in networking and data processing speeds have led to the need for high-speed cryptosystems. Military applications, financial transactions and multimedia communications are examples of particular fields and applications that require fast authentication and secure communication.

Public-key cryptosystems, which are based upon one-way mathematical functions, are popular because they do not require a complex key distribution mechanism. Commonly used public-key systems, e.g., the Rivest-Shamir-Adleman system (RSA), the Elgamal system and Elliptic-Curve Cryptosystems (ECC), utilize modular multiplication operations heavily for both encryption and decryption.

Encryption and decryption algorithms may be implemented using either software or hardware. Software implementations are less expensive and easy to modify, but slow. Hardware implementations are more expensive and difficult to modify, but are quite faster than software implementations. Hardware implementations are being studied for mass distribution because of their high speed, which results in greater convenience, increased network efficiency, greater productivity, and consequent cost savings. The speed of hardware cryptosystems depends upon the implemented algorithm complexity, the efficiency of the hardware implementation, and the technology used for the implementation. Accordingly, efficient hardware implementation of modular multipliers is essential in the design of efficient high-speed crypto-processors.

The RSA algorithm is one of the most widely used public key cryptographic methods. According to the RSA algorithm, if M represents a message to be encrypted (M being an integer produced by processing a plain text message by a symmetric algorithm, with padding if required to prevent unauthorized decryption of the message) and C represents the ciphered message, then the RSA algorithm is based upon the following three requirements: 1) finding integers e, d and N satisfying M=M^{ed} mod N; 2) it should be relatively easy to compute M^{e} and C^{d}; and 3) it should be almost impossible to find d knowing only e and N.

Typically, N is a large, difficult to factor integer, and the message block M satisfies 0≦M≦N. The ciphertext Cis computed by the relation: C=M^{e} mod N. The plaintext message can be retrieved using the decryption key d as follows: M=C^{d} mod N=(M^{e})^{d} mod N=M^{ed} mod N. With key sizes of approximately 1024 or 2048 bits, it is obvious that the speed of both encryption and decryption both heavily depend on the speed of the modulo multiplication operation.

The modulus N is defined as the product of two prime numbers p, q where N=pq. Therefore, φ(pq)=(p−1)(q−1), where φ(x) is the number of positive integers which are smaller than x and are relatively prime or coprime to x. The decryption key d is computed as: gcd(φ(N), d)=1 and 1<d<φ(N) and e≡d⁻¹ mod φ(N).

The Elgamal algorithm has two public keys, N and g, where N is a large prime number, N−1 has at least one large prime factor, and g is a primitive element mod N. Each party has its own private key KR_x (where 1<KR_x<N−1) and its own public key KU_x, which can be computed from the private key as follows: KU_x=g^{K}^{_{—}}^{x} mod N.

For USER_A to send a message M(0≦M≦N) to USER_B, USER_A must first choose a random number U (0<U<N), and then a transaction key K is computed using USER_B's public key, KU_b, as follows: K=KU_b^{U} mod N.

The ciphered message is then computed as a pair C=(c₁, c₂), where c₁=g^{U} mod N and c₂=KM mod N. It should be noted that the size of the encrypted message is twice the size of the original message. USER_B may decrypt the ciphered message C by first retrieving the transaction key K. This should be a relatively easy process for USER_B, since: K≡KU_b^{U}≡(g^{KR}^{_{—}}^{b})^{U}≡(g^{U})^{KR}^{_{—}}^{b}≡C₁^{KR}^{_{—}}^{b} mod N. The original message M is then easily retrieved by dividing C₂ by K: M=c₂/K. This methodology further illustrates that the speed of both encryption and decryption is heavily dependent upon the speed of the modulo multiplication operation.

Elliptic curve cryptosystems (ECC) are commonly viewed as being secure for both commercial and government usage. According to the IEEE 1363-2000 standard, an RSA key of 1024 bits has security equivalent to an ECC with keys of 172 bits. The cost of complex mathematical operations increases significantly with the length of the input operands. For prime fields of characteristic p>3, the elliptic curve equation is given by E: y²=x³+ax+b(mod p).

The primary operation in an ECC is point multiplication C=kP, where P is a point (x, y) on the curve and k is an integer. The multiplication is performed using group operation. The operation in the Abelian group of points on an elliptic curve is called “point addition”. This operation adds two curve points yielding another point on the curve. Using an ECC for signatures involves the repeated application of the group law. The group law using affine coordinates is shown below:

$$If P = ( {x}_{1} , {y}_{1} ) ∈ GF ( {p}^{m} ) ; then - P = ( {x}_{1} , - {y}_{1} ) . \\ If Q = ( {x}_{2} , {y}_{2} ) ∈ GF ( {p}^{m} ) , Q \neq - P , then P + Q = ( {x}_{3} , {y}_{3} ) , \\ where$$

$${x}_{3} = {λ}^{2} - {x}_{1} - {x}_{2} ;$$

$${y}_{3} = λ ( {x}_{1} - {x}_{3} ) - {y}_{1} ;$$

$$λ = \frac{{y}_{2} - {y}_{1}}{{x}_{2} - {x}_{1}} if P \neq Q ; and$$

$$λ = \frac{3 {x}_{1}^{2} + a}{2 {y}_{1}} if P = Q .$$

These field operations are all modular operations, thus requiring modular multiplication to be used heavily.

As noted above, modular arithmetic operations are of great importance in encryption systems and methodologies. Exponentiation is performed as a number of squaring and multiplication operations depending on the length of the exponent. A generalized exponentiation algorithm (hereafter referred to as Algorithm 1) is shown below, with the objective being to compute X=Y^{E}:

Algorithm 1: Exponentiation

X = 1
For i=0 to k − 1

If eᵢ = 1 Then X = X.Y
Y = Y²

Return(X)
End

In the above, k is the number of bits in the exponent E; E=eₖ₋₁, eₖ₋₂ . . . , e₂, e₁, e₀; and eᵢ is the i^{th} bit of E The above algorithm can be easily modified for modular exponentiation by replacing the multiplication in the above algorithm with a modular multiplication, as shown below. The objective of the following algorithm (hereafter referred to as Algorithm 2) is to compute X=Y^{E} Mod N:

Algorithm 2: Modular Exponentiation

X = 1;
For i = 0 to k−1;

If eᵢ = 1 Then X = (X.Y) Mod N;
Y = (Y.Y) Mod N;

Return(X);
End.

The modulo multiplication operation computes (A×B mod N), where A, B and N are k-bit integers. Modular multiplication is generally considered a difficult arithmetic operation to implement, since it involves both multiplication and division operations. The multiplication is performed either through first performing the multiplication operation and then performing the modular reduction operation through division; or through interleaving the reduction operations with the multiplication steps.

For k-bit operands, the first approach requires a k×k-bit multiplier with a 2k-bit output register followed by a 2k×k-bit divider. Thus, the hardware requirements of the first approach are quite excessive. In the second approach, the product is computed iteratively by accumulating one partial product term (2ⁱbᵢ×A) per iteration. The modular reduction operation is performed after each such iteration. The reduction step involves a trial subtraction of the modulus N from the running product P. The algorithm given below (hereafter referred to as Algorithm 3) shows the general procedure for this approach, where the trial subtractions keep the running product less than the modulus N. In this case, the adder size and the P register size are only (k+2). The two additional bits are to accommodate a sign bit and the left shift operation (P=2P). The second approach is thus more hardware efficient, but requires more additions and/or subtractions. It would be advantageous if only a few bits (the most significant bits) of P could determine the correct multiple of N to be subtracted from the running product P in order to avoid costly comparisons or trial subtractions. The objective of Algorithm 3 is to compute AB mod N:

Algorithm 3: Interleaved Modular Multiplication

P = 0;
For i = k−1 to 0

P = 2P
P = P + bᵢA
While P > N Do P = P − N

Return(P)
End

For the past two decades, the dominant approach for performing modulo multiplication has been the Montgomery algorithm, which is characterized by the following: uses the least, instead of the most, significant bits of the running product to perform an addition, rather than a subtraction; performs a shift right operation on each iteration instead of a shift left; maps operands into another domain, processes them, and maps the result back to the normal domain, so that significant pre- and post-computations are necessary; and works only if N and 2^{k} are coprime or relatively prime, i.e., gcd(N, 2^{k})=1. Algorithm 4, given below, shows a general Montgomery Product (hereafter referred to as the function “MonPro”) algorithm, in which R=2^{k}; R⁻¹ is the multiplicative inverse of R, i.e., RR⁻¹ mod N=1; and N′ is defined where R×R⁻¹−N×N′=1; i.e., N′=−N⁻¹ mod R. The objective of Algorithm 4 is to compute MonPro(A, B, N):

Algorithm 4: Montgomery's Multiplication

tmp1 = A × B
tmp2 = (tmp1 × N′) mod R
tmp3 = (tmp1 + tmp2.N)/R
If tmp3 ≧ N Then tmp3 = tmp3 − N
Return tmp3
End

The MonPro(A, B, N) algorithm does not directly yield the required result of AB mod N, but rather MonPro(A, B, N)=ABR⁻¹ mod N. Accordingly, instead of operating on the inputs A and B directly, the MonPro algorithm operates on the N-residues of A and B. The N-residue of some number A is defined as Ā=(A×R)mod(N). The N-residue domain contains all the values between 0 and (N−1). Therefore, there is a one-to-one mapping between the elements of the N-residue domain and integers between 0 and (N−1). To compute the N-residue of A, the MonPro procedure is also used for this purpose as follows:

A̅=MonPro(A,R²,N)=(A×R²×R⁻¹)mod N=(A×R)mod N.

However, this requires the precomputation of R² mod N. Accordingly, the modulo multiplication A-B mod N is computed as follows:
1. Precompute R⁻¹, N⁻¹, and N′. These are non-trivial computations that require the use of the Euclidean algorithm
2. Precompute R² mod N
3. Precompute A=MonPro(A, R², N)=(A×R) mod N
4. Precompute B=MonPro(B, R², N)=(B×R) mod N

$$\begin{matrix}5. Compute \overline{C} = MonPro ( \overline{A} , \overline{B} , N ) \\ = ( \overline{A} \times \overline{B} \times {R}^{- 1} ) mod N \\ = ( A \times B \times R ) mod N , \\ = ( C \times R ) mod N , where C = AB \\ = the N \text{-} residue of C\end{matrix}$$

6. Compute C=MonPro( C̅,1,N).

Precomputation of steps 1 and 2 above needs to be performed only once for a given system with a particular value of k and N. However, precomputations of steps 3 and 4 must be performed for each new set of MonPro operands. Thus, the operands A and B should first be mapped into the N-residue domain where A is mapped into Ā=AR mod N, and B is mapped into B̅=BR mod N. The two mapped values Ā and B̅ are passed as input arguments to the Montgomery product procedure MonPro(Ā, B̅, N) and the final result C̅ is converted back from the N-residue domain (C=MonPro( C̅, 1, N).

For a single modular multiplication operation, the cost of precomputations and mapping to and from the N-residue domain is unacceptably excessive. However, for modulo exponentiation X^{E} mod N, where modulo multiplication is performed repeatedly, this cost is tolerable since mapping is performed only once at the beginning to the N-residue domain and once at the end from the N-residue domain. No intermediate mapping is required and the exponentiation process is performed on the mapped N-residue input. The below algorithm (hereinafter referred to as Algorithm 5) shows the modulo exponentiation algorithm utilizing the MonPro procedure. The primary objective of Algorithm 5 is to compute X=Y^{E} mod N:

Algorithm 5: Modular Exponentiation Using Montgomery Algorithm

Y̅ = MonPro(Y, R², N)
X̅ = MonPro(1, R², N)
For i = 0 to k − 1

{
If eᵢ = 1 Then X̅ =MonPro( X̅, Y̅, N)
Y̅ =MonPro( Y̅, Y̅, N)
}

X = MonPro( X̅, 1, N)
Return(P)
End

Algorithm 4 is a relatively inefficient implementation of the Montgomery multiplication method. A more efficient simplified radix 2 version is shown in the below algorithm (hereinafter referred to as Algorithm 6). In Algorithm 6, two addition operations are performed per iteration. Thus, the total number of additions per MonPro computation is (2k+1). Using a Carry Propagate Adder (CPA) with order(k) delay, denoted as O(k), the delay of one MonPro computation is O(2k²). Alternatively, if Carry Save Adders (CSAs) are used, the main MonPro loop will have a constant delay irrespective of the value of k. In this case, two CSAs will be required for the main loop, and a carry propagate adder will be required to both assimilate the result and perform the final correction step (If P>N Then P=P−N). With CSAs, the loop delay equals the delay of the two CSAs plus the delay of two AND gates (computing bᵢA and p₀N) plus the delay of latching the results into registers. Accordingly, with k loop iterations, the loop delay of one MonPro computation is O(2k).

The objective of Algorithm 6 is to compute MonPro(A, B, N).

Algorithm 6

P = 0
For i = k−1 to 0

| { | |
|---|---|
| P = P +bᵢA | |
| P = P +p₀N | (p₀ is the LSB of P) |
| P = P/2 | (right shift) |

}

If P > N Then P = P − N
Return(P)
End

Table I below summarizes the delay for Modulo Exponentiation where T_{CPA} is the worst-case delay of a CPA and T_{CSA} is the delay of a CSA.

TABLE I
Delay of Montgomery Multiplication and Exponentiation

| | Using CPA | Using CSA |
|---|---|---|
| Ā = MonPro(A, R², N) | (2k + 1)T_{CPA} | kT_{Loop}_{_{—}}_{Delay} + 2T_{CPA} |
| B̅ = MonPro(B, R², N) | (2k + 1)T_{CPA} | kT_{Loop}_{_{—}}_{Delay} + 2T_{CPA} |
| C = MonPro( C̅, 1, N) | (2k + 1)T_{CPA} | kT_{Loop}_{_{—}}_{Delay} + 2T_{CPA} |
| Total delay per a single | 4(2k + 1)T_{CPA} | 4kT_{Loop}_{_{—}}_{Delay} + 8T_{CPA} |
| Modulo Multiplication | | |
| Operation | | |
| Average # of MonPro | 1.5k | 1.5k |
| invocation for exponentiation | | |
| Total exponentiation delay | (3k² + 7.5k + 3)T_{CPA} | (1.5k² + 3k) × T_{Loop}_{_{—}}_{Delay} + |
| | | (3k + 6)T_{CPA} |

None of the above methods or algorithms, taken either singly or in combination, is seen to describe the instant invention as claimed. Thus, a an apparatus and method for high-speed modular multiplication and division solving the aforementioned problems is desired.

### SUMMARY OF THE INVENTION

The method for high-speed modulo multiplication is a method for multiplying integers A and B modulus N that is optimized for high speed implementation in an electronic device, which may be implemented in software, but is preferably implemented in hardware. The multiplication is performed on devices requiring no more than k+2 bits, where k is the number of significant bits in A, B, and N where the most significant bit of N must be 1. The method computes the running product bᵢAW, where AW is either A when the previous running product is negative, or W when the previous running product is positive, W being a negative quantity designated the N-conjugate of A, which equals A−N if A−N is negative, or A−2N otherwise. On each iteration, the magnitude of the running product is reduced by a scaling factor no greater than 2N according to the state of the two most significant bits of the running product when carry propagate adders are used, or three bits of the running product carry and product sum when carry save adders are used.

When implemented by a carry propagate adder, the running product is simply summed by the adder. When implemented by a carry save adder, the product carry and the product sum are separately reduced according to the state of the sum of the three most significant bits of the product carry and product sum. With slight modification, the method can produce the quotient of A×B/N as well as AB (mod N).

These and other features of the present invention will become readily apparent upon further review of the following specification and drawings.

### BRIEF DESCRIPTION OF THE DRAWINGS

FIG. 1 is a schematic diagram of a circuit using a carry propagate adder configured to apply a method for high-speed modulo multiplication according to the present invention.

FIG. 2 is a schematic diagram of a circuit using carry save adders configured to apply a method for high-speed modulo multiplication according to the present invention.

FIG. 3 is a schematic diagram of an alternative embodiment of a circuit using carry save adders configured to apply a method for high-speed modulo multiplication according to the present invention.

FIG. 4 is a flow diagram of a method for high-speed modulo multiplication according to the present invention.

Similar reference characters denote corresponding features consistently throughout the attached drawings.

### DETAILED DESCRIPTION OF THE PREFERRED EMBODIMENTS

The present invention is directed towards an apparatus and method for high-speed modulo multiplication and division. In its simplest form, the method is directed towards a method for high-speed modulo multiplication. The method includes an algorithm that may be implemented in software, but is preferably implemented in hardware for greater speed. The apparatus includes a circuit configured to carry out the algorithm. The circuit may be incorporated into the architecture of a computer processor, into a security coprocessor integrated on a motherboard with a main microprocessor, into a digital signal processor, into an application specific integrated circuit (ASIC), or other circuitry associated with a computer, electronic calculator, or the like. The method may be modified so that the circuit may include carry propagate adders, or the circuit may include carry save adders. With additional modification, the method can not only perform modulo multiplication, but also simultaneous multiplication and division.

A primary application for the apparatus and method is in connection with networked computer or digital communication devices, where the method and circuitry provide for high speed performance of modular arithmetic operations involved in the encryption and decryption of messages, where the method and the circuitry provide increased speed for greater circuit efficiency, increased productivity, and lower network overload and costs.

Turning first to a method for high-speed modulo multiplication using carry propagate adders, the method is used when it is required to compute P=AB mod N, where the multiplicand A, the multiplier B, and the modulus N are all k-bit unsigned numbers. The modulus N is typically, for cryptographic algorithms, chosen to be a large odd number so that 2^{k-1}<N≦2^{k}−1. Thus, the smallest possible value of N=Nₘᵢₙ=2^{k-1}+1; and the largest possible value of N=Nₘₐₓ=2^{k}−1.

The steps of the algorithm are shown below in Algorithm 7.

Algorithm 7

a) Initialization:
Pₛ ← 0
W ← A−N
If W≧ 0 Then W ← W−N;
i ← k−1

b) Shift:

P ← 2Pₛ

c) Add:

If bᵢ = 1 Then

If P < O Then P ← P + A Else P ← P + W

d) Scale:

Case Pₖ₊₁ P_{K} is:

00: Pₛ ← P
11: If(i=0) Then Pₛ ← P + N Else Pₛ ← P
01: Pₛ ← P − 2N
10: Pₛ ← P + 2N

end Case
If i > 0 Then {i = i − 1; Go To Shift}
e) Correction:

If P_{S} <0 Then Pₛ ← Pₛ + N Else

If Pₛ > N Then Pₛ ← Pₛ − N

In Algorithm 7, the parameter W is the N-conjugate of A and is a negative quantity, and is the only parameter that needs to be precomputed. The product P is computed iteratively by simple addition and left-shifting of k-partial product terms (bᵢA). The product is computed cumulatively so that the value of the running product P in each iteration is kept within k-bits by adding/subtracting a scaling quantity that is a multiple of the modulus (αN) so that it does not affect the final result (x mod N=(x±αN) mod N).

Whenever bᵢ≠0, the add step (step c of Algorithm 7) will always reduce the magnitude of the running product P. This is done by adding either A or its N-conjugate (W), whichever has an opposite sign to P. The product P=AB mod N is represented in signed 2's complement format using k+2 bits, i.e., two additional bits are needed. One bit, Pₖ₊₁, is used as a sign bit while the other is required to accommodate the left shift operation (step b of Algorithm 7). This leads to area-efficient implementations with registers and adders that are only k+2 bits. Thus, the smallest allowed value of P is Pₘᵢₙ, which is equal to −2^{k+1}; and the largest allowed value of P is Pₘₐₓ, which is equal to 2^{k+1}−1.

By adding/subtracting the proper multiple of N to/from the running product P, the scaling step (step d of Algorithm 7) guarantees that no overflow may occur as a result of the shift operation performed in step b. Thus, the objective of the scaling step is to obtain a scaled running product value Pₛ with a reduced magnitude so that its left-shifted value (step b of Algorithm 7) is within the allowed range, i.e., Pₘᵢₙ≦2Pₛ≦Pₘₐₓ. Thus, the lower bound of the scaled running product, Pₛ(min), is −2k, and the upper bound of the scaled running product, Pₛ(max), is 2^{k}−1. Further, the correction step (step e of Algorithm 7) requires no more than one addition/subtraction to get the correct result.

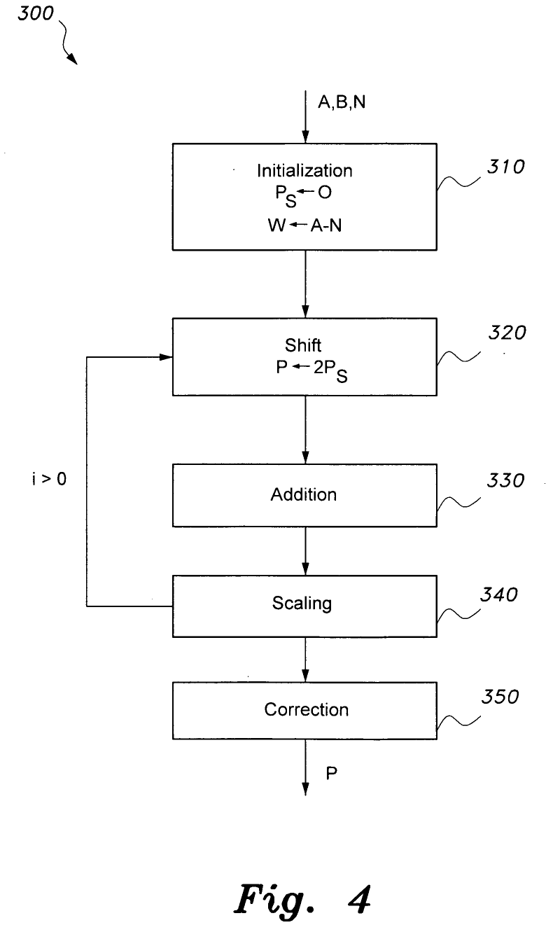

FIG. 4 is a simplified flowchart briefly summarizing the steps of Algorithm 7. The parameters A, B and N are k-bit long integers that are input to the algorithm. In the initialization step 310, the running product is initialized to zero by setting all of the bits of Pₛ=0. Pₛ is stored in a register that is k+2 bits long. The parameter W is initialized by computing the N-conjugate of A (step a of Algorithm 7), which is either A−N (if A<N) or A−2N (if A≧N). Finally, an index is set to k−1 so that a loop can iterate through all of the bits of the integer B.

In the first step of the loop, the running product is left shifted by one bit, as indicated at block 320. The loop performs an addition, as indicated at step 330, for each bit in B that is a binary 1, beginning in the first iteration with the most significant bit of B. If the k+1 bit (the sign bit) in the running product register is a binary 1 (the partial sum is negative), then the addition at step 330 comprises adding A to the running product; otherwise, the N-conjugate of A (a negative integer) is added to the running product.

In the next step of the loop, the running product is scaled, as indicated at 340, to ensure that the result will be k-bits long. If the k+1 and k bits of the running product are both equal to 0 or both equal to 1, no scaling is necessary, except that when both of the bits are binary 1, N is added to the running product in the last iteration of the loop, i.e., for the least significant bit of B. If the k+1 and k bits of the running product are binary 0 and binary 1, respectively, then 2N is subtracted from the running product. If the k+1 and k bits of the running product are binary 1 and binary 0, respectively, then 2N is added to the running product.

The index is then decremented and the loop is reiterated until all bits in B have been tested.

Upon completion of k iterations through the loop, a correction may be made to the running product, if necessary, as indicated at step 350. If the k+1 bit of the running product is a binary 1, i.e., the running product is negative, then the modulus N is added to the running product, or if the running product is greater than the modulus, then the modulus N is subtracted from the running product. The output of the algorithm is the corrected running product P, which is equal to AB (mod A).

The scaling factor α is computed so that Pₛ(min)≦P+αN≦Pₛ(max). The scaling factor is fully defined by inspecting the two most significant bits (Pₖ₊₁, Pₖ) of the running product P. Thus, only four cases need to be considered, i.e., (Pₖ₊₁, Pₖ)=00, 01, 10 or 11.

For (Pₖ₊₁, Pₖ)=00 or 11, the magnitude of P fits within k-bits and, accordingly, can be left-shifted without risk of overflow. Thus, in these cases, the value of P is passed without any scaling, i.e., α=0. In the last iteration of the algorithm, however, N is added instead of zero if (Pₖ₊₁, Pₖ)=11 in order to improve the execution efficiency of the correction step (step e of Algorithm 7).

In the case where (Pₖ₊₁, Pₖ)=01, P is a large positive number with a 1 in the (k+1)^{th} bit position and, accordingly, must be scaled down by adding a negative scaling quantity. Since the k least significant bits of Pare unknown, the scaling constant α (which is negative in this case) must satisfy the following two conditions:

Max(P)+αNₘᵢₙ≦Pₛ(max); and (a)

Min(P)+αNₘₐₓ≧Pₛ(min). (b)

For the above condition (a), αNₘᵢₙ≦Pₛ(max)−Max(P), which can alternatively be expressed as α(2^{k-1}+1)≦(2^{k}−1)−(2^{k+1}−1), so that α≦−2^{k}/(2^{k-1}+1). By defining δ₁ as 2/(2^{k-1}+1), α is finally expressed as α≦−2+δ₁.

For the above condition (b), αNₘₐₓ≧Pₛ(min)−Min(P), which can alternatively be expressed as α(2^{k}−1)≧(−2^{k})−(2^{k}), so that α≧−2^{k+1}/(2^{k}−1). By defining δ₂ as 2/(2^{k}−1), α is finally expressed as α≧−2−δ₂ Thus, for (Pₖ₊₁, Pₖ)=01, the proper value of α is given by −2.

For the case where (Pₖ₊₁, Pₖ)=10, P is a large negative number with a magnitude of k+1 bits, and α is positive. Accordingly, P must be scaled up by adding a proper multiple of N. In this case, the scaling factor α must satisfy the following conditions:

Max(P)+αNₘᵢₙ≧Pₛ(max); and (c)

Min(P)+αNₘₐₓ≦Pₛ(min). (d)

For the above condition (c), αNₘᵢₙ≦Pₛ(min)−Min(P), which can alternatively be expressed as α(2^{k-1}+1)≦−2^{k}−(−2^{k+1}), so that α≦2^{k}/(2^{k-1}+1). By defining δ₃ as 2/(2^{k-1}+1), α is finally expressed as α≦2−δ₃.

For the above condition (d), αNₘₐₓ≦Pₛ(max)−Max(P), which can alternatively be expressed as α(2^{k}−1)≦(2^{k}−1)−(−2^{k+1}+2^{k}−1), so that α≦2^{k+1}/(2^{k}−1). By defining δ₄ as 2/(2^{k}−1), α is finally expressed as α≦2+δ₄. Thus, for (Pₖ₊₁, Pₖ)=10, the proper value of a is 2.

It should be noted that without the magnitude reduction of the running product P resulting from the addition step (step c of Algorithm 7), it would not have been possible to find solutions for the scaling factor α in all cases using two bits. Further, it should be noted that whereas Montgomery's algorithm works only for odd moduli, Algorithm 7 works for both odd and even moduli. To show that the above scaling process also applies to even moduli, only the value of Nₘᵢₙ needs to be changed from (2^{k-1}+1) to 2^{k-1}. This will only affect conditions (a) and (d) where the value of δ₁ and δ₄ becomes zero. However, this does not alter the selected values of the scaling factors α, proving that the algorithm can work for even as well as odd moduli.

The operation of the algorithm can be illustrated by an example. The numbers used will be trivial for the sake of brevity. Suppose it is desired to find 2×3 (mod 4). Then A=2, B=3, and N=4. The number of bits, k, should be large enough to encompass the significant digits of A, B, and N. Thus, k=3 and, accordingly, the size of the running product is k+2=5 bits.

In the initialization step, Pₛ=00000 (the 0 at k+2 is the sign bit and the 0 at k+1 is an extra bit to accommodate the left shifts and prevent overflow). W=A−N=2−4=−2, which is expressed as 11110 in 2's complement. Finally, the index i for the selected bit of B is initialized to k−1=3−1=2.

In the first iteration of the loop, the left shift of Pₛ=00000, and since B is expressed as 011 in binary, b₂=0, no addition is performed. Pₖ₊₁, Pₖ=00, so no scaling is done. Index i is decremented to a value of 1.

In the second iteration, the left shift of P is again 00000. Since b₁=1 and Pₖ₊₁=0, P=P+W=00000+11110=11110. In the case statement, Pₖ₊₁, Pₖ is 11, so that no scaling is needed. The index/is decremented to 0. In the third iteration through the loop, the left shift produces P=11110, and since b₀=1 and Pₖ₊₁=1, P=P+A=11110+00100=00010. In the case statement, Pₖ₊₁, Pₖ is 11, and since i=0, scaling requires that Pₛ=P+N=111110+000100=000010. In the correction step, Pₖ₊₁=0, and since Pₛ=2, Pₛ<N, so that no correction is required, and by the algorithm 2×3 (mod 4)=2. It is easily verified that the result is correct by performing the multiplication and division in base 10.

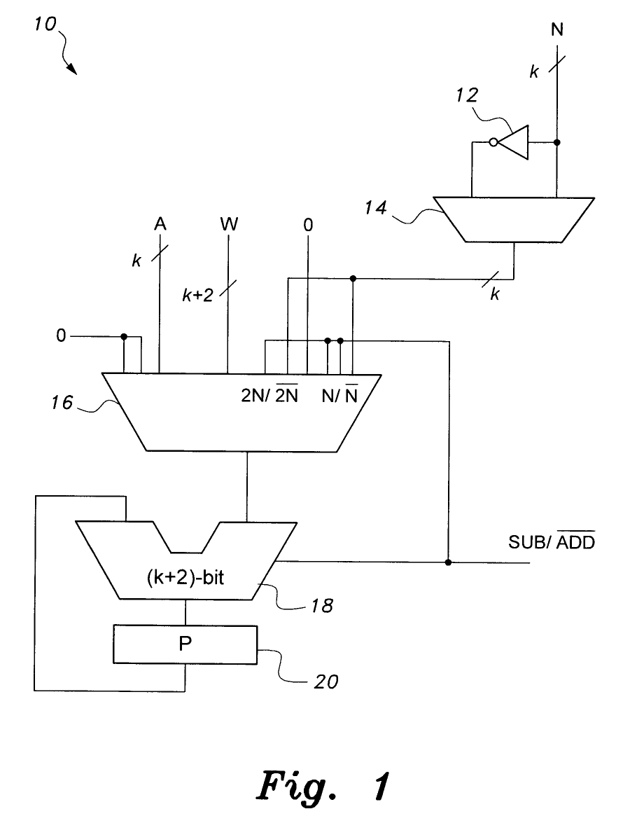

FIG. 1 is a schematic diagram of an exemplary circuit for implementing Algorithm 7, as described above, using a single k+2 bit carry propagate adder 18. In circuit 10, the modulus N is a k-bit number fed into a first multiplexer 14. “k” inverters 12 feed the 1's complement of N through the same multiplexer. These parameters are fed into a second multiplexer 16 (which is hardwired to provide either Nor its inverse N̅ as a first input, 2N or its inverse 2N as a second input, W is the third input, while A is the fourth input). An addition/subtraction control signal cycles a desired input from multiplexer 16 to one input of the adder 18, depending upon which addition or subtraction step or which scaling step is called for, and recursively cycles P or Pₛ from register 20 to the other input of adder 18, and triggers the addition or scaling operation.

The clock period of circuit 10 is equal to the worst-case delay of the (k+2) CPA 18 plus the delay of the two multiplexers 14 and 16 plus the latching delay of the P-register 20. The clock period is dependent on the value of k, since the worst-case adder delay depends on the carry propagation delay through all of the (k+2) adder bits.

Algorithm 7 may be modified to yield a quotient resulting from dividing (A.B) by N; i.e., the modified algorithm implements a multiplier-divider which computes (A×B/N, yielding both a quotient Q and a remainder P, i.e., A×B=(Q×N)+P, where |P|<N. In the following Algorithm 8, the multiplier divider requires a k+2 bit adder and register, which is far more efficient than the SRT divider, which requires a 2k+2 bit adder and register:

Algorithm 8

a) Initialization:

Pₛ ← 0; Q ← 0
W ← A − N; g ← 1
If W≧ 0 Then W ← W−N; g ← 2;
i ← k−1

b) Shift:

P ← 2Pₛ; Q ← 2Q

C) Add:

If bᵢ = 1 Then

If Pₖ₊₁ = 1 Then P ← P + A

Else P ← P + W; Q ← Q + g;
d) Scale:

Case Pₖ₊₁ Pₖ is

00: Pₛ ← P
11: If (i=0) Then Pₛ ← P + N; Q ← Q − 1

Else Pₛ ← P

01: Pₛ ← P − 2N; Q ← Q + 2
10: Pₛ ← P + 2N; Q ← Q − 2

end Case
If i> 0 Then {i = i − 1; Go To Shift}

e) Correction:

If P_{S} < 0 Then Pₛ ← Pₛ + N; Q ← Q − 1; Else

If Pₛ > N Then Pₛ ← Pₛ − N; Q ← Q + 1.

Algorithm 8 is substantially the same as Algorithm 7, with the addition of Quotient Q and constant g. Q is initialized to 0 and g is initialized to 1 if A<N or to 2 if A>N. Q is left shifted on each iteration through the loop and incremented by g when the corresponding bit of B is equal to 1. Q is scaled whenever the running product P is, according to the rules set forth above. Q is corrected by decrementing Q by 1 when P is negative, or by adding 1 when P is greater than modulus N. It should be noted that whereas the above Algorithm 8 can yield both the remainder and the quotient, the Montgomery algorithm can only yield the remainder.

More efficient hardware implementations of Algorithm 7 are possible if carry save adders (CSAs) are utilized rather than the CPAs. The major advantage of this approach is getting a constant clock period, which is independent of the adder size, i.e., independent of k. In this case, the product P is represented in a redundant format as two signed components: a sum component PS and a carry component PC. Since the scale factors used in the scaling step depend on the most significant bits of P, a 3-bit CPA is used to add the three most significant bits (i.e., the (k+1)^{th}, the k^{th}, and the (k−1)^{th}) of PS and PC. The resulting three sum bits Z_{2:0}=PS_{k+1:k-1}+PC_{k+1:k-1} are used to choose a proper scale factor in the scaling step. It should be noted that the resulting Z bits are not necessarily equal to the most significant bits of P; i.e., P_{k+1:k-1}. The computation error ε is given by ε=P_{k+1:k-1}−Z_{2:0}, where 0≦ε<2^{k-1}. Accordingly, Z_{2:0}≦P_{k+1:k-1}≦Z_{2:0}+ε, or, given an upper bound, Z_{2:0}≦P_{k+1:k-1}≦Z_{2:0}+001.

Given this upper bound of the error ε, the proper values of the scale factor α may be computed for various values of Z. The following Algorithm 9 is similar to Algorithm 7, but utilizes CSAs, as described above:

Algorithm 9

a) Initialization:

PS, PC ← 0
W ← A−N
If W≧ 0 Then W ← W−N;
i ← k−1

b) Shift:

PS ← 2PS; PC ← 2PC

c) Add:

If bᵢ = 1 Then

If P < 0 Then (PS, PC) = PS + PC + A
Else (PS, PC) = PS + PC + W

d) Scale:

Case Z₂ Z₁ Z₀ is

000, 111: (PS, PC) ← (PS, PC) + 0
001: (PS, PC) ← (PS, PC) − N
010: (PS, PC) ← (PS, PC) − 2N
011: If PS < 0 then (PS, PC) ← (PS, PC) ± 2N

Else (PS, PC) ← (PS, PC) − 2N

110: (PS, PC) ← (PS, PC) + N
100: (PS, PC) ← (PS, PC) + 2N
101: (PS, PC) ← (PS, PC) + N

end Case
If i > 0 Then {i = i − 1; Go To Shift}

e) Assimilate:

P ← (PS + PC) -- Carry propagate addition

f) Correction:

If Pₖ₊₁ = 1 Then P ← P + N Else

while P ≧ N Do P ← P − N.

Similar to the scaling procedure shown above, the scaling factor α may also be computed for the CSA implementation so that the minimum and maximum ranges are described by Pₛ(min)≦P+αN≦Pₛ(max). The scale factor value is fully defined by inspecting the three sum bits (Z₂Z₁Z₀). Accordingly, eight separate cases must be considered. In the following analysis, Nₘᵢₙ is set equal to 2^{k-1}, rather than (2^{k-1}+1), in order to guarantee that the algorithm works for both odd and even moduli. Thus, the only restriction is that N has a 1 in the most significant bit position.

In the first four cases, we consider Z₂Z₁Z₀=XY0; where the following condition is satisfied: XY0≦P_{k+1:k-1}≦XY1, i.e., Z₂Z₁=Pₖ₊₁Pₖ, irrespective of the error value. In this case, the scale factor is the same as that computed in the CPA algorithm (Algorithm 7), irrespective of the values of X or Y Thus, we have:

Z₂Z₁Z₀=000; α=0;

Z₂Z₁Z₀=110; α=0;

Z₂Z₁Z₀=010; α=−2; and,

Z₂Z₁Z₀=100; α=2;

In the next case, we consider Z₂Z₁Z₀=111. For maximum error, we may also consider Z₂Z₁Z₀=111+001=000. In either of these situations, we have Z₂Z₁Z₀ε{111, 000}, and no scaling is required, i.e., α=0. In the form given above, Z₂Z₁Z₀=111, which implies that α=0.

In the sixth case we consider, Z₂Z₁Z₀=001. Taking the maximum error into consideration, Z₂Z₁Z₀ε{001, 010} and P is positive within the range of 2^{k-1}≦P≦2^{k}+2^{k-1}−3. Under these conditions, the scale factor is negative and must satisfy the following conditions (where α is a negative quantity):

Max(P)+αNₘᵢₙ≦Pₛ(max); and (a)

Min(P)+αNₘₐₓ≦Pₛ(min). (b)

The first condition can be rewritten as αNₘᵢₙ≦Pₛ(max)−Max(P), which can further be rewritten as αNₘᵢₙ≦(2^{k}−1)−(2^{k}+2^{k-1}−3)=−2^{k-1}+2. Or, if we define δ as 2^{-k+2}, then α≦−1+δ, or α≦−1.

The second condition can be rewritten as αNₘₐₓ≧Pₛ(min)−Min(P), which can further be rewritten as α(2^{k}−1)≧−2^{k}−2^{k-1}=−1.5×2^{k}; thus, we have α≧−1.5, or α≧−1. Accordingly, when Z₂Z₁Z₀=001, the scale factor limits are −1≧α≧−1, i.e., α=−1.

In the seventh case, we consider Z₂Z₁Z₀=101. Thus, taking the maximum error into consideration, Z₂Z₁Z₀ε{101, 110}. P is negative with a value range of −2^{k+1}+2^{k-1}≦P≦−2^{k-1}−3. The scale factor, in this situation, is positive and must satisfy the following conditions:

Max(P)+αNₘₐₓ≦Pₛ(max); and (c)

Min(P)+αNₘᵢₙ≧Pₛ(min). (d)

The first condition, (c), can be rewritten as αNₘₐₓ≦Pₛ(max)−Max(P), which can further be rewritten as αNₘₐₓ≦(2^{k}−1)−(−2^{k-1}−3)=1.5×2^{k}+2. Or, if we define δ as 3.5/(2^{k}−1), then α≦1.5+δ, or α≦1 for k>3.

The second condition, (d), can be rewritten as αNₘᵢₙ≧Pₛ(min)−Min(P), so that α(2^{k-1})≧−2^{k}−(−2^{k+1}+2^{k-1})=2^{k-1}. Thus, we have α≧1. Accordingly, when Z₂Z₁Z₀=101, the scale factor limits are 1≧α≧1, i.e., α=1.

In the final case, we consider Z₂Z₁Z₀=011. This case may only occur if PS and PC are either both negative or both positive quantities. In this case, if the error ε=000, i.e. Pₖ₊₁Pₖ=Z₂ Z₁=01, then the required scale factor is α=−2. However, if the error ε=001, then P is a large negative value with Pₖ₊₁PₖPₖ₋₁=100 requiring a positive scale factor of α=2. This latter case (ε=001 and Z₂Z₁Z₀=011) may only occur if both PS and PC are negative quantities. This condition is easily detected by testing that either PS<1, PC<1, or the carry-out bit Z₃=1.

Table II (below) lists the derived values of the scale factor α for various combinations of Z₂Z₁Z₀:

TABLE III
Derived Values of the Scale Factor

| Z₂ Z₁ Z₀ | Scale Factor (α) |
|---|---|
| 000 | 0 |
| 001 | −1 |
| 010 | −2 |
| 011 | −2 if PS ≧ 0; 2 if PS < 0 |
| 100 | 2 |
| 101 | 1 |
| 110 | 0 |
| 111 | 0 |

Operation of Algorithm 9 is similar to operation of Algorithm 7. The sum component and carry component, PS and PC, respectively, are initialized to 0 in (k+2)-bit long registers. The N-conjugate of the multiplicand, W, is computed in the same manner as in Algorithm 7, and the loop counter i is initialized to k−1. In the first step of the loop, the shifting step, both the PS and PC registers are shifted left by one bit.

In the next step of the loop, the addition step, the current bit of the multiplier (starting with the most significant bit) is tested to see if the bit is equal to one. To determine the sign of P, the 3-most significant bits of PS and PC are added using a carry propagate adder. The most significant bit of the sum indicates the sign of P If bᵢ=1 and P is negative, then PS, PC and the multiplicand A are added using a carry-save adder, storing the sum component in PS and the carry component in PC. If P is positive, then PS, PC and W (the N-conjugate of the multiplicand A) are added using carry-save addition.

In the next step of the loop, the scaling step, the magnitude of the running product Pas represented by the sum component PS and carry component PC is reduced by an appropriate scaling factor. The case step is used to determine the proper scaling factor by adding the k+1, k, and k−1 bits of PS to the corresponding bits of PC using carry propagate addition and comparing the result to the chart in Algorithm 9. The scaling factor, PS, and PC are added together using carry-save addition. The resulting partial sum and partial carry are passed back in the loop to be shifted (Algorithm 9, step b) after decrementing the loop index.

After the last iteration, the next step is the assimilation step in which P is computed by adding the PS and PC registers using carry propagate addition. The final step is the correction step. If the result is negative, then N is added to the result. Otherwise, if P≧N, then N is subtracted from P until P is less than Nor equal to zero.

A moderately complex partial example will make operation of Algorithm 9 clear. It is desired to compute 14×83 (mod 100), so that A=14_{decimal}=000001110, B=83=001010011, N=1100=001100100, and k=7. The size of the adders is k+2=9 bits. PS and PC are initialized to binary 000000000, W=14−100=−86=110101010 in 2's complement notation, and the counter is initialized to i=6.

On the first iteration through the loop, PS and PC remain zero after left shifting. Since the sixth bit of integer B is one (b₆=1), and since P=0 (P is obtained by adding PS and PC using carry propagate addition), W is added to (PS,PC) so that PS=W, and PC=0 since there are no carry bits. Z₂Z₁Z₀=110+000=110 (the k+1, k, and k−1 bits of PS are 110 and the k+1, k, and k−1 bits of PC are 000). By the chart, (PS,PC)=(PS,Pc)+N, so that PS=111001110 and PC=001000000. The counter is decremented to i=5 and the loop reverts to the shift step.

Upon shifting left by one bit, PS=110011100 and PC=010000000. In the add step, bₛ=0, so that no addition occurs. Z₂Z₁Z₀=110+010=000, so that the scaling factor is zero and no scaling occurs. The counter is decremented to i=4, and program flow moves to the shift step.

Upon left shifting by one bit, PS=100111000 and PC=100000000. Since b₄=1, and the sign of P is positive (the sign of P is obtained by adding the k+1, k, and k−1 bits of PS and PC), so that W is added to (PS,PC) and PS=010010010 and PC=101010000. Z₂Z₁Z₀=010+101=111, so that the scaling factor is zero and no reduction is needed. The counter is decremented to i=3, and the loop continues in the same fashion through the remaining bits of the multiplier B. Assimilation and correction produce the final result, 14×83 (mod 100)=62.

It should be noted that whereas Montgomery's algorithm works only for odd moduli, Algorithms 7 and 9 work for both odd and even moduli. Further, the CSA algorithm (Algorithm 9) requires 3-bit carry propagate adders (CPAs) in order to determine the sign of Pas required by step (c), and to determine the value of Z₂Z₁Z₀ used in the scaling step (d).

Table III (below) shows that, at most, two additions may be required during the correction step (Algorithm 9, step f) to get the final result under extreme values of P and N. More specifically, Table III illustrates the following:

(a) If the assimilated value of P (Algorithm 9, step e) is positive, up to one subtraction operation may be required;

(b) If the assimilated value of P(Algorithm 9, step e) is negative, up to two addition operations may be required;

(c) For the case of Z₂Z₁Z₀=110, the bottom two rows of Table III show that even though the derived correction factor value of α=0 would properly scale the running product P, a correction factor of α=1 is preferred, since a following correction step would require only up to one addition as compared to two additions for α=0.

TABLE IIII
Upper Bound for the Number of Correction Steps

| | | | | Worst case |
|---|---|---|---|---|
| Case | Scale | Range of Scaled P Value | | correction |
| Z₂ Z₁ Z₀ | Factor α | Pₘₐₓ + αNₘᵢₙ | Pₘᵢₙ + αNₘₐₓ | needed |
| 000 | 0 | 2^{k} − 3 | 0 | 1 Sub/None |
| 001 | −1 | 2^{k} − 3 | −2^{k-1} + 1 | 1 Sub/1 Add |
| 010 | −2 | 2^{k} − 3 | −(2^{k} − 2) | 1 Sub/1 Add |
| 011 | −2 | 2^{k} − 1 | −(2^{k-1} − 2) | 1 Sub/1 Add |
| 011 | +2 | −(2^{k-1} + 3) | −2 | 2 Add |
| 100 | 2 | −2^{k} | 2^{k} − 5 | 2 Add/None |
| 101 | 1 | −2^{k} | 2^{k-1} − 4 | 2 Add/None |
| 111 | 0 | −2^{k-1} | 2^{k-1} − 3 | 1 Add/None |
| 110 | 0 | −2^{k} | −3 | 2 Add/1 Add |
| 110 | 1 | −2^{k-1} | 2^{k-1} − 3 | 1 Add/None |

Similar to that shown above, with minor modification, Algorithm 9 can be made to work as a multiplier-divider, which computes (A×S/N), yielding both the quotient Q and the remainder P, such that A×B=Q×N+P, where |P|<N. This modification is shown in Algorithm 10, as follows:

Algorithm 10

a) Initialization:

PS, PC ← 0; Q ← 0
W ← A−N; g ← 1
If W ≧ 0 Then W ← W−N; g ← 2;
i ← k−1

b) Shift:

PS ← 2PS; PC ← 2PC; Q ← 2Q

C) Add:

If bᵢ = 1 Then

If P < 0 Then (PS, PC) ← (PS, PC) + A

Else (PS, PC) ← (PS, PC) + W; Q ← Q + g

d) Scale:

Case Z₂ Z₁ , Z₀ is

| 000, 111: (PS, PC) ← (PS, PC) + 0 | |
|---|---|
| 001: (PS, PC) ← (PS, PC) − N; | Q ← Q + 1 |
| 010: (PS, PC) ← (PS,PC) − 2N; | Q ← Q + 2 |

011: If PS < 0 then (PS, PC) ← (PS, PC) + 2N; Q ← Q−2

Else (PS, PC) ← (PS, PC) − 2N; Q ← Q + 2

| | |
|---|---|
| 01X: (PS, PC) ← (PS, PC) − 2N; | Q ← Q + 2 |
| 110: (PS, PC) ← (PS, PC) + N; | Q ← Q−1 |
| 100: (PS, PC) ← (PS, PC) + 2N; | Q ← Q−2 |
| 101: (PS, PC) ← (PS, PC) + N; | Q ← Q−1 |

end Case
If i > 0 Then {i = i − 1; Go To Shift}

e) Assimilate:

P ← (PS + 2PC) -- Carry propagate addition

f) Correction:

If Pₖ₊₁ = 1 Then P ← P + N; Q ← Q-1;

Else while P ≧ N Do P ← P − N; Q ← Q + 1

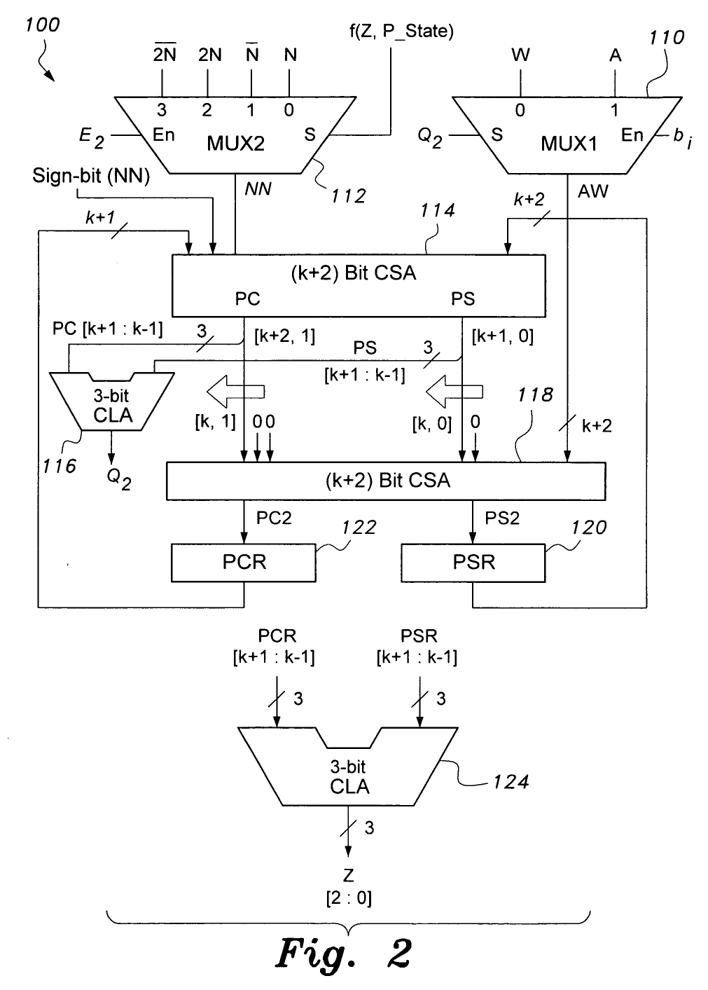

FIG. 2 illustrates an exemplary circuit 100 for implementing Algorithm 9, where two (k+2)-bit carry save adders (CSAs) 114, 118 are used. A 3-bit carry-look ahead adder (CLA) 116, 124 is used following each CSA 114, 118, respectively. The partial sum and carry components of P are designated PS and PC, respectively. The top CSA 114 inputs the appropriate scaling factor by second multiplexer 112 to add in the scale factor αN, thus computing P+αN. The shift step is accomplished through hardwiring of shifted bits of the PS and PC outputs of the top CSA 114 into the inputs of the bottom CSA 118 (which also receives input from first multiplexer 110).

Thus, CSA 118 performs the shift and add operations (steps b and c, respectively, in Algorithm 9), i.e., it computes 2Pₛ+2P_{C+b}ᵢAW, where AW is chosen to be either the multiplicand A, its conjugate W, or zero. The value of AW is chosen based on the value of bᵢ (the i^{th} bit of B) and sign of the previously computed value of P (Q2 in FIG. 2).

The sign (Q2) of the product P, which decides whether A or its N-conjugate W is to be used in the add step (step d of Algorithm 9), is computed after the product is scaled to fit into k-bits by the top 3-bit CLA 116. Table IV (below) shows the possible values of the output sum bits of the top 3-bit CLA 116 (Q₂Q₁Q₀) and the corresponding sign of the product P. It is clear that Q₂ may be used to determine the sign of P. The bottom 3-bit CLA 124 computes Z₂Z₁Z₀, which is needed for the scaling step and input to multiplexer 112 to input the proper scaling factor to CSA 114.

It should be noted that multiplexers 110, 112 are provided with enable control to allow for all zero outputs. Further, to avoid pre-computation and storage of the scaling value (−N) and, accordingly, (−2N), N̅+1 is added whenever −N is to be used as a scaling quantity. N̅ is obtained by inverting N, while the 1 is added as the least significant bit of PC. Thus, in the case of a −N or −2N scaling value, the least significant bit of PC is forced to be 1; otherwise, it is equal to zero. This is simply achieved by forcing the least significant bit of PC to equal the sign bit of NN (output of multiplexer 112). The choice of a proper scaling value ε{0, N, 2N, −N, −2N} is controlled by the value of Z The hardware implementation of FIG. 2 allows for computation of the modular multiplication in k iterations plus, at most, two correction cycles.

Contrary to Montgomery's algorithm, where N-residues of both A and B need to be pre-computed, the only quantity that needs to be pre-computed in Algorithms 7 or 9 is W=A−N, which is much simpler than the N-residue computation. It should be noted that the N-residue of x is defined as x̅=xR mod N, where R=2^{k}.

TABLE IV
Determining the Sign of the Running Product P After Scaling

| Q₂Q₁Q₀ | Q₂Q₁Q₀ + \|ε\| | Sign of Resulting P (scaled in k-bits) |
|---|---|---|
| 000 | 001 | Positive |
| 001 | 010 | Positive |
| 010 | 011 | Combination is impossible (requires more than |
| | | k-bits) |
| 011 | 100 | Combination is impossible (requires more than |
| | | k-bits) |
| 100 | 101 | Combination is impossible (requires more than |
| | | k-bits) |
| 101 | 110 | Combination is possible if ε = 2^{k-1}, then negative |
| | | result |
| 110 | 111 | Negative |
| 111 | 000 | Result has a small magnitude that fits in less |
| | | than k-bits. Adding A or W will work, with a |
| | | negative result assumed. |

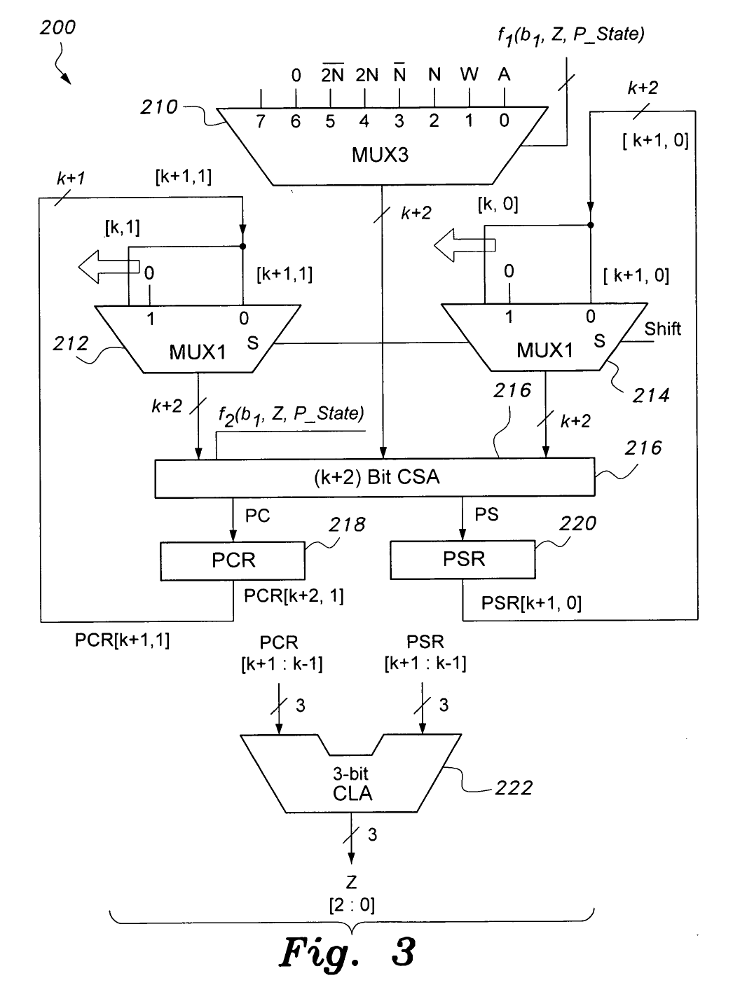

In the embodiment of FIG. 2, two stages were utilized, with each stage having a (k+2)-bit CSA plus a 3-bit CSA. In the alternative embodiment of FIG. 3, circuit 200 uses a single (k+2)-bit CSA and a single 3-bit CLA. Circuit 200 utilizes a third multiplexer 210 in combination with a pair of multiplexers 212, 214. All input quantities, including the scaling factors and the addition quantities A and Ware input to multiplexer 210, which outputs the appropriate quantity based on the values of bᵢ, Z, and the step (Add-step or Scaling step) currently being executed. Multiplexer 210 feeds output to the (k+2)-bit CSA 216. The sum and carry output components of CSA 216 are stored in the product sum register (PSR) 220, and the product carry register (PCR) 218, respectively. Multiplexers 212 and 214 perform left shifting of PC and PS, respectively. The 3-bit CLA 222 is used to determine the sign of P (step c of Algorithm 9) in one state, and to compute the value of Z needed for the scaling step (step f of Algorithm 9) in another state.

The following Table V illustrates the delay of the modular multiplication of Algorithms 7 and 9 using the CPA and CSA methodologies, as described above:

TABLE V
Delay of Multiplication and Exponentiation

| | Using CPA | Using 2CSA |
|---|---|---|
| Algorithm 7 and 9 Modulo | (2k + 2)T_{CPA} | kT_{Loop Delay} + 2.375T_{CPA} |
| Multiplication | | |
| Average no. of Modulo | 1.5k | 1.5k |
| Multiplication invocation | | |
| for exponentiation | | |
| Total Delay | (3k² + 3k)T_{CPA} | 1.5k²T_{Loop}_{_{—}}_{Delay} + |
| | | 3.5625kT_{CPA} |

It is to be understood that the present invention is not limited to the embodiments described above, but encompasses any and all embodiments within the scope of the following claims.

1: A method for high-speed modulo multiplication, comprising the steps of:
(a) entering a multiplicand, multiplier, and modulus as k-bit binary unsigned integers, a most significant bit of the modulus being set to one;
(b) subtracting the modulus from the multiplicand, and if a non-negative result is obtained, subtracting the modulus again, in order to define a negative N-conjugate of the multiplicand;
(c) initializing a running product to zero in a (k+2)-bit running product register and initializing a bit counter to k−1;
(d) shifting the running product left by one bit;
(e) after step (d), when the k_{bit counter} bit of the multiplier is a binary 1, adding the multiplicand to the running product when the running product is negative or adding the N-conjugate of the multiplicand to the running product when the running product is non-negative;
(f) reducing the running product in magnitude by an integer multiple of the modulus when the running product is greater than or equal to 2^{k} and when the running product is less than or equal to −(2^{k}) to obtain −(2^{k})≦ running product <2^{k}, thereby keeping the running product within k bits;
(g) decrementing the bit counter by 1;
(h) repeating steps (d), (e), (f) and (g) sequentially for each bit of the multiplier until the bit counter is decremented to 0, and if the k+1 and k bits of the running product are both equal to one on the iteration for bit zero of the multiplier, adjusting the running product by adding the modulus to the running product; and
(i) after step (h), adding the modulus to the running product when the running product is negative or subtracting the modulus from the running product when the running product is greater than the modulus.

2: The method for high-speed modulo multiplication according to claim 1, wherein step (f) comprises the step of subtracting twice the modulus from the running product when the running product is greater than or equal to 2^{k}.

3: The method for high-speed modulo multiplication according to claim 2, wherein said subtracting step comprises the steps of representing twice the modulus in 2's complement form and adding the 2's complement form to the running product.

4: The method for high-speed modulo multiplication according to claim 1, wherein step (f) comprises the step of adding twice the modulus to the running product when the running product is less than or equal to −(2^{k}).

5: The method for high-speed modulo multiplication according to claim 1, wherein step (e) comprises the steps of:
inputting the running product as a first input to a (k+2)-bit carry propagate adder;
inputting the multiplicand as a second input to the carry propagate adder when the running product is negative;
inputting the N-conjugate of the multiplicand as the second input to the carry propagate adder when the running product is positive; and
outputting an addition product of the first and second inputs from the carry propagate adder to the running product register.

6: The method for high-speed modulo multiplication according to claim 1, wherein step (f) comprises the steps of:
inputting the running product as a first input to a (k+2)-bit carry propagate adder;
inputting a 2's complement representation of twice the modulus as a second input to the carry propagate adder when the running product is greater than or equal to 2^{k};
inputting twice the modulus as a second input to the carry propagate adder when the running product is less than or equal to −(2^{k});
outputting an addition product of the first and second inputs from the carry propagate adder to the running product register.

7: The method for high-speed modulo multiplication according to claim 1, wherein the k+1 bit of said running product register represents a sign bit for 2's complement representation of negative integers.

8: The method for high-speed modulo multiplication according to claim 1, wherein:
step (c) further comprises the step of initializing a quotient in a quotient register to zero and the step of initializing a quotient increment constant to one when the N-conjugate of the multiplicand is generated by subtracting the modulus from the multiplicand once, or to two when the N-conjugate of the multiplicand is generated by subtracting the modulus from the multiplicand twice;
step (d) further comprises the step of shifting the quotient register one bit to the left;
step (e) further comprises the step of adding the quotient increment to the quotient when k_{bit counter} is equal to binary 1 and the running product is non-negative;
step (f) further comprises the step of adding two to the quotient when the running product is greater than or equal to 2^{k} and subtracting two from the quotient when the running product is less than or equal to −(2^{k});
step (h) further comprises the step of subtracting one from the quotient if the k+1 and k bits of the running product are both equal to one on the iteration for bit zero of the multiplier; and
step (i) further comprises the step of subtracting one from the quotient when the running product is negative or adding one to the quotient when the running product is greater than or equal to the modulus;
whereby the quotient of the multiplicand times the multiplier divided by the modulus is also produced.

9: An electronic circuit for high-speed modulo multiplication, comprising:
a first data switch configured for sending output of a binary representation of a k-bit modulus or an inverse of the binary representation of the k-bit modulus upon receipt of a first control signal;
a second data switch having an input electrically connected to the output of the first data switch, the second data switch being configured for sending output of the binary representation of the k-bit modulus, the inverse, twice the binary representation of the k-bit modulus, twice the inverse, a binary representation of a k-bit multiplicand, an N-conjugate of the multiplicand, or binary zero upon receipt of the second control signal;
a (k+2) bit register for storing a running product, the (k+2) bit register being adapted to allow shifting of the running product by 1 bit to the left; and
a (k+2)-bit carry propagate adder circuit having a first input electrically connected to the output of the second data switch, a second input electrically connected to the register, an output electrically connected to the register, and means for receiving the second control signal, the adder circuit being configured for adding or subtracting the output from the second switch to or from the running product and to convert the inverses to 2's complement for addition to the running product according to the state of the second control signal.

10: The electronic circuit according to claim 9, wherein said first and second data switches comprise a first multiplexer and a second multiplexer, respectively.

11: A computer processor having an electronic circuit according to claim 9 incorporated therein.

12: A security coprocessor integrated on a motherboard with a main microprocessor, the security coprocessor having an electronic circuit according to claim 9 incorporated therein.

13: A digital signal processor having an electronic circuit according to claim 9 incorporated therein.

14: An application specific integrated circuit having an electronic circuit according to claim 9 incorporated therein.

15: A method for high-speed modulo multiplication, comprising the steps of:
(a) entering a multiplicand, multiplier, and modulus as k-bit binary unsigned integers, a most significant bit of the modulus being set to 1;
(b) subtracting the modulus from the multiplicand, and if a non-negative result is obtained, subtracting the modulus again, in order to define a negative N-conjugate of the multiplicand;
(c) initializing a running sum component and a running carry component to zero in (k+2)-bit running sum component and running carry component registers, respectively, and initializing a bit counter to k−1;
(d) shifting the running sum component left by one bit and the running carry component left by one bit;
(e) after step (d), when the k_{bit counter} bit of the multiplier is a binary 1, adding the multiplicand to the running sum and running carry components using carry save addition when the running product is negative or adding the N-conjugate of the multiplicand to the running sum and running carry components using carry save addition when the running product is non-negative, the sign of the running product being dependent upon the most significant bit resulting from the carry-propagate addition of the (k+1), k and (k−1) bits of the running sum and carry components;
(f) reducing the magnitude of the running product by an integer multiple of the modulus when addition of the three most significant bits of the running sum and running carry components shows that the running product is greater than or equal to 2^{k-1} and when the running product is less than or equal to −(2^{k}) to obtain −(2^{k})≦ running product <2^{k}, thereby keeping the running sum and running carry components within k bits, the magnitude of the running product being represented by its running sum and running product components;
(g) decrementing the bit counter by 1;
(h) repeating steps (d), (e), (f) and (g) sequentially for each bit of the multiplier until the bit counter is decremented to 0;
(i) adding the running sum component to the running carry component to obtain the running product; and
(j) after step (i), adding the modulus to the running product when the running product is negative or repeatedly subtracting the modulus from the running product when the running product is greater than the modulus until the running product is less than the modulus.

16: The method for high-speed modulo multiplication according to claim 15, wherein step (f) comprises the step of subtracting twice the modulus from the running sum and running carry components when the result of adding the three most significant bits of the running sum component and the running carry component are bit values 010 or when the three most significant bits of the running sum component and the running carry components are both positive and their sum equals 011.

17: The method for high-speed modulo multiplication according to claim 16, wherein said subtracting step comprises the steps of representing twice the modulus in 2's complement form and adding the 2's complement form to the running sum and running carry components.

18: The method for high-speed modulo multiplication according to claim 15, wherein step (f) comprises the step of adding twice the modulus to the running sum and running carry components when the result of adding the three most significant bits of the running sum component and the running carry component are bit values 100 or when the three most significant bits of the running sum component and the running carry components are both negative and their sum equals 011.

19: The method for high-speed modulo multiplication according to claim 15, wherein step (f) comprises the step of adding the modulus to the running sum and running carry components when the result of adding the three most significant bits of the running sum component and the running carry component are bit values 110 or 101.

20: The method for high-speed modulo multiplication according to claim 15, wherein step (f) comprises the step of subtracting the modulus from the running sum and running carry components when the result of adding the three most significant bits of the running sum component and the running carry component are bit values 001.

21: The method for high-speed modulo multiplication according to claim 15, wherein the k+1 bits of said running sum component register and said running carry components represent a sign bit for 2's complement representation of negative integers.

22: The method for high-speed modulo multiplication according to claim 15, wherein:
step (c) further comprises the step of initializing a quotient in a quotient register to zero and the step of initializing a quotient increment constant to one when the N-conjugate of the multiplicand is generated by subtracting the modulus from the multiplicand, the quotient increment constant being initialized to two when the N-conjugate of the multiplicand is generated by subtracting twice the modulus from the multiplicand;
step (d) further comprises the step of shifting the quotient register one bit to the left;
step (e) further comprises the step of adding the quotient increment to the quotient when k_{bit counter} is equal to binary 1 and the running product is non-negative;
step (f) further comprises the step of adding two to the quotient when the sum of the three most significant bits of the running sum and running carry components are bit values 010 or when the three most significant bits of the running sum component and the running carry components are both positive and their sum equals 011, step (f) further comprising subtracting two from the quotient when the sum of the three most significant bits of the running sum and running carry components are bit values 100 or when the three most significant bits of the running sum component and the running carry components are both negative and their sum equals 011, step (f) further comprising adding one to the quotient when the sum of the three most significant bits of the running sum and running carry components are bit values 001, and subtracting one from the quotient when the sum of the three most significant bits of the running sum and running carry components are bit values 110 or 101; and
step (j) further comprises the step of subtracting one from the quotient when the running product is negative or adding one to the quotient when the running product is greater than or equal to the modulus;
whereby the quotient of the multiplicand times the multiplier divided by the modulus is also produced.

23: An electronic circuit for high-speed modulo multiplication, comprising:
a first data switch configured for sending output of a binary representation of a binary representation of a k-bit multiplicand, an N-conjugate of the multiplicand, or binary zero upon receipt of first and second control signals;
a second data switch configured for sending output of a binary representation of the k-bit modulus, an inverse of the k-bit modulus, twice the binary representation of the k-bit modulus, twice the inverse, or binary zero upon receipt of a third control signal;
a (k+2) bit register for storing a running sum component;
a (k+2) bit register for storing a running carry component;
a first 3-bit carry look ahead adder configured to add the k+1, k and k−1 bits of the running sum and running carry component registers to output the third control signal;
a first carry save adder configured to add the contents of the running sum component register, the running carry component register, and the second data switch;
a second carry save adder having a first input receiving the output of the first data switch, and second and third inputs receiving a running sum output and running carry output from the first carry save adder, the second and third inputs being shifted left one bit, the second carry save adder having a first output stored in the running sum register and a second output stored in the running carry register; and
a second 3-bit carry look ahead adder configured to receive the k+1, k, and k−1 bits of the running sum and running carry component output of the first carry save adder left-shifted by one bit, and to output the second control signal to the first multiplexer.

24: The electronic circuit according to claim 23, wherein said first and second data switches comprise a first multiplexer and a second multiplexer, respectively.

25: A computer processor having an electronic circuit according to claim 23 incorporated therein.

26: A security coprocessor integrated on a motherboard with a main microprocessor, the security coprocessor having an electronic circuit according to claim 23 incorporated therein.

27: A digital signal processor having an electronic circuit according to claim 23 incorporated therein.

28: An application specific integrated circuit having an electronic circuit according to claim 23 incorporated therein.

29: An electronic circuit for high-speed modulo multiplication, comprising:
a first data switch configured for sending output of a binary representation of a binary representation of a k-bit multiplicand, an N-conjugate of the multiplicand, a binary representation of the k-bit modulus, an inverse of the k-bit modulus, twice the binary representation of the k-bit modulus, twice the inverse, or binary zero, depending upon the state of first and second control signals
a (k+2) bit register for storing a running sum component;
a (k+2) bit register for storing a running carry component;
a second data switch connected to the running sum component register and configured to output the running sum component or the running sum component shifted left by one bit, depending upon the state of the control signal;
a third data switch connected to the running carry component register and configured to output the running carry component or the running carry component shifted left by one bit, depending upon the state of the control signal;
a (k+2)-bit carry save adder having first, second and third inputs connected to the outputs of the first, second and third data switches, respectively, the carry save adder having a first output connected to the running sum component register and a second output connected to the running carry component register; and
a 3-bit carry look ahead adder having a first input connected to the running sum component register and a second input connected to the running carry component register, the carry look ahead adder being configured to add the k+1, k, and k−1 bits of the registers, the carry look ahead adder having an output forming the first control signal to the first data switch.

30: The electronic circuit according to claim 30, wherein said first, second and third data switches comprise first, second, and third multiplexers, respectively.

31: A computer processor having an electronic circuit according to claim 30 incorporated therein.

32: A security coprocessor integrated on a motherboard with a main microprocessor, the security coprocessor having an electronic circuit according to claim 30 incorporated therein.

33: A digital signal processor having an electronic circuit according to claim 30 incorporated therein.

34: An application specific integrated circuit having an electronic circuit according to claim 30 incorporated therein.
